(19) United States
(12) Patent Application Publication
(10) Pub. No.: US 2026/0362105 A1
(43) Pub. Date: Nov. 12, 2026

(54) CONTACTLESS RF-BASED SERVICE CONFIRMATION SYSTEM FOR PORTABLE SANITATION ASSETS

(71) Applicant: Daenatech Corp., Aurora (CA)

(72) Inventors: Arash Sheikhtaheri, Aurora (CA); Soufia Naseri, Aurora (CA); Amir Sheikh Taheri, North York (CA); Aria Sheikhtaheri, North York (CA)

(73) Assignee: Daenatech Corp., Aurora (CA)

(21) Appl. No.: 19/436,027

(22) Filed: Dec. 30, 2025

Related U.S. Application Data
(60) Provisional application No. 63/803,298, filed on May 9, 2025.

(51) Int. Cl. H04W 4/80; H04W 4/38; A47K 11/02

(52) U.S. Cl. CPC H04W 4/80; H04W 4/38; A47K 11/02

(57) ABSTRACT

A contactless service confirmation system for portable sanitation assets utilizing RF technologies such as RFID, BLE, WiFi, LoRa or others. Each portable unit is embedded with a tamper-proof RF tag. Technicians' service tools are equipped with RF readers that detect proximity to the tag, automatically logging timestamps and service durations. A control module with sensors and wireless communication facilitates real-time monitoring and cloud-based analytics. The system ensures tamper-proof, automated service verification, improves recordkeeping, and enhances accountability with minimal technician interaction.

### CROSS REFERENCE TO RELATED APPLICATIONS

This application claims priority to provisional U.S. Patent Application No. 63/803,298, filed on May 09, 2025, entitled “CONTACTLESS RF-BASED SERVICE CONFIRMATION SYSTEM FOR PORTABLE SANITATION ASSETS ”, the aforementioned application being hereby incorporated by reference in its entirety.

### FIELD OF THE INVENTION

The present invention relates generally to service verification systems, and more particularly to an automated, contactless confirmation method for verifying the completion of services, especially vacuum servicing, rendered to portable restrooms by Portable Restroom Operators (PROs). The invention utilizes RF technologies such as RFID, BLE, WiFi, or LoRa or others to confirm, log, and timestamp services performed.

### BACKGROUND OF THE INVENTION

Portable restrooms are typically serviced by the rental company as part of the agreement with event organizers. The service schedule is determined in advance and can range from once per month to daily, depending on the estimated usage at a given location. Service generally includes waste removal, replenishment of clean water and deodorizer, restocking of consumables such as toilet paper and hand sanitizer, interior cleaning, and inspection for any damage or malfunction.

However, accurately predicting usage levels can be challenging. Factors such as the positioning of units relative to others at the site can lead to significant differences in usage. For example, one unit may be used 50 times per day, while another nearby may see only five uses, yet both are serviced at the same frequency. This mismatch often results in some units becoming unsanitary well before their scheduled servicing, creating an unpleasant experience for users and reflecting poorly on the rental company and the industry as a whole. These issues highlight a clear need for improved portable restroom designs that address these shortcomings and enhance both hygiene and user satisfaction.

Currently, there is no reliable or automated way to confirm whether a technician has serviced a portable toilet. Service providers often rely on technicians manually reporting completed jobs, which has led to disputes and mistrust between management and field operators. The industry standard involves technicians taking before-and-after photos using mobile apps and scanning QR codes on each toilet. However, this process is error-prone and often neglected due to its complexity and extra steps. Therefore, there is a need for an automated solution that eliminates the dependency on manual input and confirms the service with timestamped proof, duration tracking, and unique identification of the serviced unit. The invention supports multiple RF technologies, enabling flexible implementations such as BLE for low-power proximity detection, WiFi for high-data-rate environments, LoRa for Long-Range rural deployments, or EPC2 for robust tag-based identification.

### SUMMARY OF THE INVENTION

The present invention relates to an enhanced portable restroom system that integrates electrical power and wireless communication technologies to improve servicing efficiency, hygiene, and operational oversight. The system is housed within a standard portable restroom unit. The restroom is typically defined by a set of walls, a door and door frame, a roof, and a base. The base incorporates a waste tank, a fresh water tank, and a compartment housing the control electronics.

Central to the invention is the integration of a contactless radio-frequency (RF) service confirmation system. Each portable restroom unit is equipped with an embedded RF tag (such as RFID including UHF protocols, BLE, WiFi, LoRa or others) positioned in a known, tamper-resistant location-typically within the waste tank. This tag is programmed with a unique ID associated with the specific unit.

Service tools-such as vacuum wands or freshwater hoses are outfitted with corresponding RF readers. When a technician performs a service, the reader automatically detects the presence of the RF tag, records a timestamp, and measures the duration of contact or proximity. This interaction provides verifiable, tamper-proof confirmation that the unit was serviced. It also captures performance metrics such as time spent on each unit, which can be used for auditing and technician evaluation. The RF reader transmits this data wirelessly to a cloud-based dashboard or centralized database, accessible by management for real-time monitoring and historical recordkeeping. This system is more reliable and less susceptible to manipulation than prior systems which are based on photos, QR codes, or manual check-ins.

In addition to the RF system, the restroom is equipped with a control module comprising a microprocessor, memory, and sensors. These sensors monitor conditions such as: Waste level (via ultrasonic or pressure sensors), Fresh water level, Door open/close status, Lock engaged status and Ambient temperature and humidity (optional).

The system is powered by an integrated power supply, which may include batteries, solar panels, or both, depending on deployment conditions. Additional features to improve user experience include, automatic, touchless flushing triggered by a proximity or infrared sensor, an electric pump connected to the freshwater tank for bowl cleaning, an internal lighting system that activates upon door opening, an electric ventilation fan to reduce odor and temperature.

The restroom system also supports a method of operation whereby the door sensor detects user entry and the system activates the light and ventilation fan. If the door is subsequently locked within a pre-set timeframe, the system logs the use as valid. Upon exit, the user may trigger a touchless flush sensor, increasing water flow via the electric pump. All sensor data and service logs are transmitted wirelessly to the management system.

This system dramatically improves accountability and transparency in portable restroom servicing. By eliminating the need for manual confirmation, it reduces technician error or non-compliance and enables data-driven decisions on service frequency and resource allocation. It also supports high-traffic environments, where timely maintenance is essential for hygiene and user satisfaction.

This invention provides a fully automated and contactless system with minimal training or technician interaction required. It is adaptable with various RF technologies. The cloud-based integration enables real-time monitoring and is more reliable than photo and QR-based methods.

It is therefore an object of the present invention to eliminate disputes over whether a unit was serviced.

It is another object of the present invention to provide automatic, tamper-proof confirmation.

It is another object of the present invention to reduce reliance on technician compliance.

It is another object of the present invention to enable management to monitor performance based on duration and frequency of service.

It is another object of the present invention to support accountability and improve recordkeeping.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1 is a perspective view of a contactless radio-frequency (RF) service confirmation device assembled on a vacuum wand according to an embodiment of the present invention;

FIGS. 2 and 3 are exterior views of a portable restroom illustrating the integration of the service confirmation system in accordance with the present invention;

FIG. 4 is an exploded perspective view of the RF reader tag assembly according to the present invention;

FIG. 5 is a flowchart illustrating a method for automated service confirmation using the RF reader system, detailing sequential steps of the process;

FIG. 6 is a data flow diagram of the contactless RF service confirmation device, showing communication between system components;

FIG. 7 is a sample screen/interface of a dashboard generated by the system according to the present invention, and

FIG. 8 is a flowchart illustrating the logic for determining a “Valid Service Event” based on detection parameters and service tool verification.

### DETAILED DESCRIPTION OF THE INVENTION

Referring now to the drawings, wherein like reference numerals designate identical or corresponding parts throughout the several views, the present invention relates to an enhanced portable restroom system integrating contactless service verification, wireless communication, and automated user amenities.

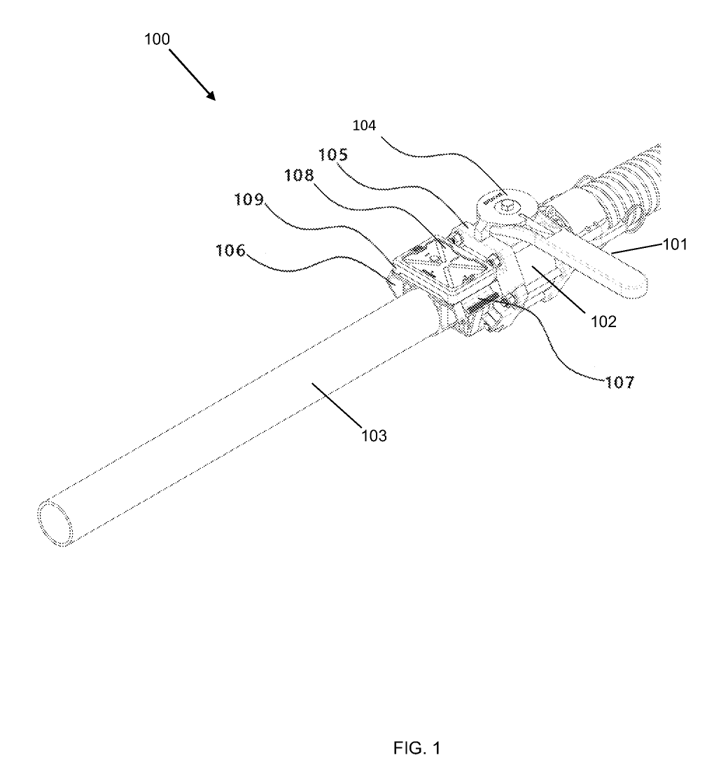

FIG. 1 illustrates a vacuum wand assembly 100 used for servicing the portable restroom unit . The vacuum wand 100 includes a handle of wand vacuum valve 101, a wand vacuum valve 102 configured to control the suction flow during servicing, and a wand vacuum nozzle 103 adapted for insertion into the waste water tank to extract waste. The vacuum wand 100 outfitted with an RF reader assembly 108 for automatic detection of the embedded RF tag located in the portable restroom unit. The RF reader 108 is mounted on the wand using a magnetic trigger 104, a mounting adapter 105, and a mounting dock 106. A spring-loaded sliding lock 107 provides secure but removable attachment. The RF reader 108 captures the unique ID of the RF tag when in proximity and transmits the data to a remote system. A bumper 109 encircles the reader to protect against impact damage.

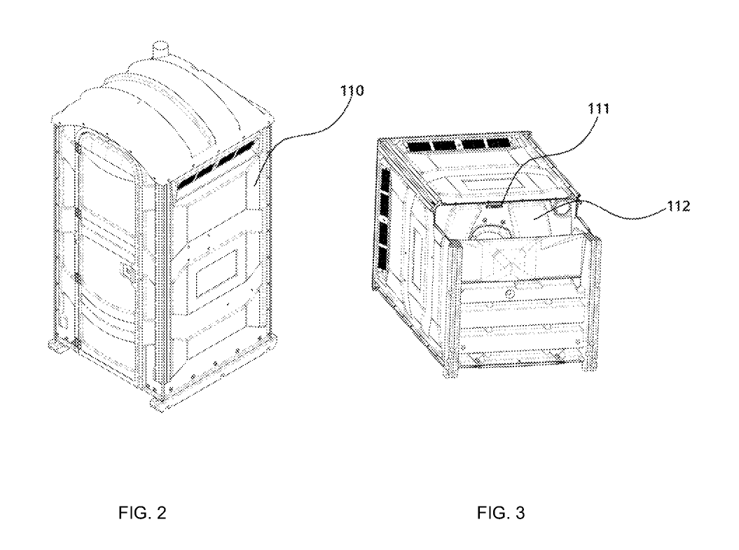

FIG. 2 and 3 depicts an overall exterior view of the portable toilet 110, which comprises a structural assembly of walls, a door, a roof, and a base. The base houses a waste water tank and a fresh water tank, as well as a compartment for control electronics. FIG. 3 presents a sectional view of the portable toilet showing the RF tag 111 securely installed within the interior of the waste water tank 112. The placement is tamper-resistant and ensures that the tag is only detectable when the service tool is properly inserted for servicing.

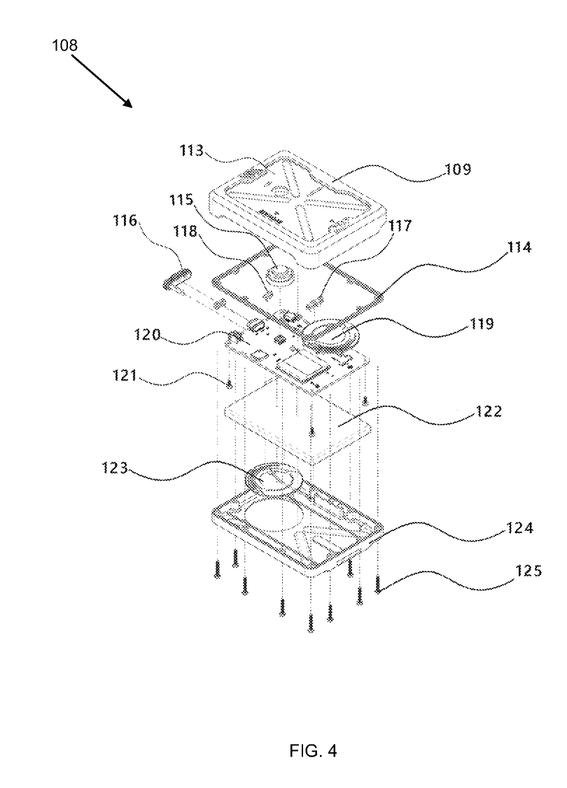

FIG. 4 provides a detailed view of the RF reader assembly 108. The RF reader 108 includes a bumper 109, a top casing 113 enclosing the upper portion of the device, and a main gasket 114 to provide water and dust sealing. A button cover 115 protects operational controls, and a port seal 116 safeguards charging or communication ports. The RF reader 108 further includes a warning indicator light 117 and a charging indicator light 118 for user status feedback. An RF antenna 119 communicates with the restroom’s RF tag 111, while a wireless communication antenna 123 transmits service data to a cloud-based system.

A control board 120, secured by control board screws 121, manages all reader functions and is powered by a rechargeable Li-Po battery 122. The lower portion of the reader is enclosed by a bottom casing 124, fastened by enclosure screws 125.

The control board 120, which comprises a microprocessor or microcontroller unit configured to manage the operations of the reader assembly 108. The control board 120 executes firmware that enables the detection of service confirmation tags/beacons (e.g., RFID or BLE), processes signal data, generates timestamps, and controls the transmission of data to a remote or cloud-based system.

The reader 108 further includes a wireless charger, which facilitates inductive charging of the internal power source without the need for direct physical connection. This feature enhances the device’s operational durability and ease of maintenance by eliminating exposed charging ports. The wireless charging interface may be compatible with industry-standard charging pads or be specifically designed for use with a proprietary charging station.

The housing of the device may be formed from durable, impact-resistant materials such as reinforced polymers or metal alloys to withstand the environmental conditions commonly encountered during field servicing. The housing may further incorporate mounting brackets configured to be mounted onto a servicing wand, which is used in conjunction with portable toilet maintenance operations. The casing is designed to be water-resistant or waterproof to protect sensitive components from moisture, debris, and chemical exposure during the servicing process.

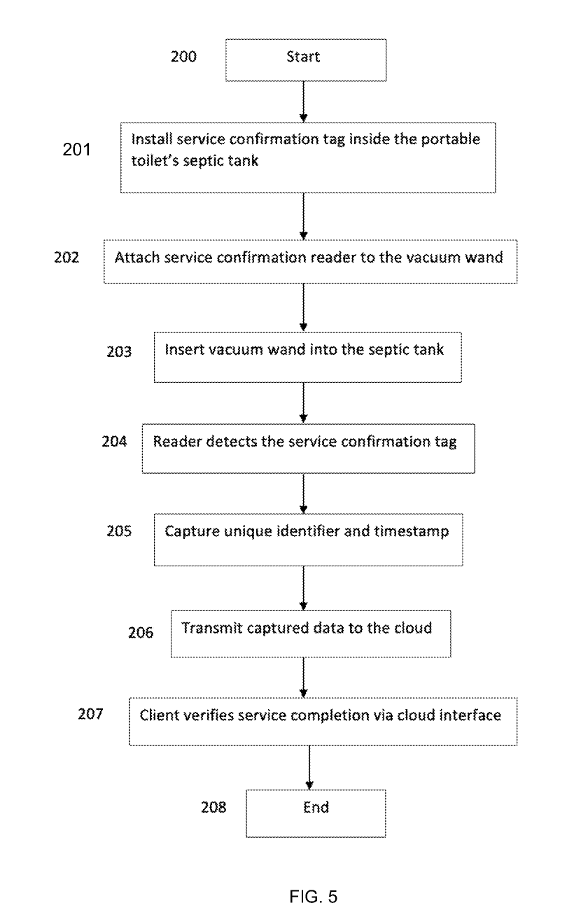

Referring now to FIG. 5, a method is illustrated for automated service confirmation of a portable toilet system. The process begins at step 200 with the preparation and installation of system components. Specifically, a service confirmation tag or beacon—utilizing wireless technologies such as RFID, Bluetooth Low Energy (BLE), or an equivalent—is affixed within the interior of the septic tank of a portable toilet (step 201).

A service confirmation reader is then attached to the vacuum wand that is employed during routine servicing operations of the toilet (step 202). During the service procedure, the vacuum wand, equipped with the reader, is inserted into the septic tank (step 203).

Upon entering proximity to the installed tag or beacon, the reader automatically detects the wireless signal broadcasted by the tag (step 204). The reader then captures the unique identifier of the tag along with a corresponding timestamp, thereby verifying the completion of the service event (step 205).

The captured identification and timestamp data are transmitted to a cloud-based platform for storage and processing (step 206). A client or authorized party may subsequently access this data through a cloud interface to confirm that the service has been properly executed (step 207).

The described system operates in a fully automated manner, requiring no manual intervention for the detection of the tag, the acquisition of service data, or the transmission of said data to the cloud-based system.

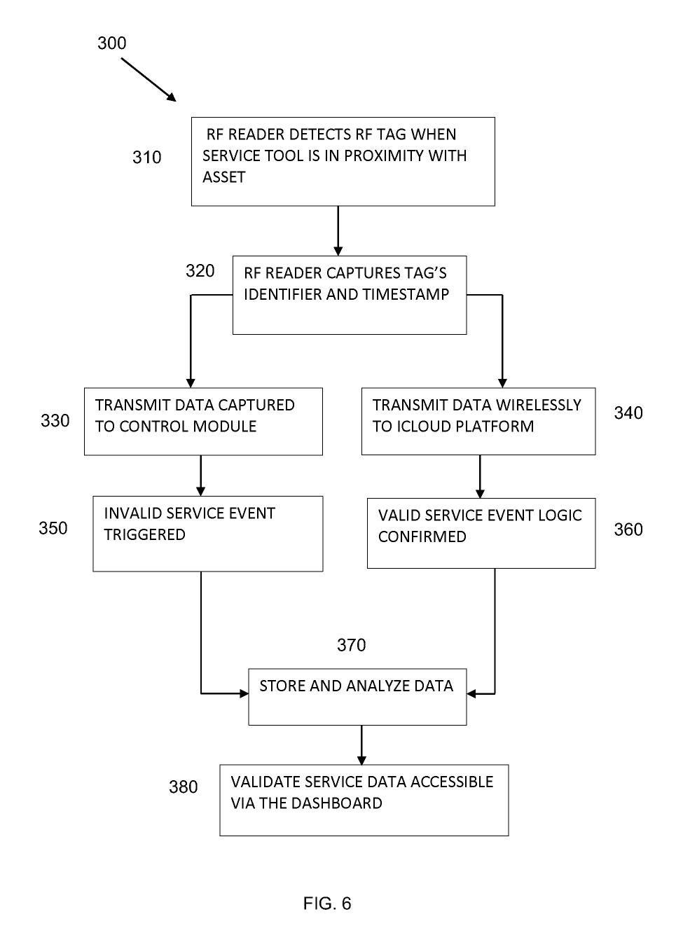

FIG. 6 shows data flow chart 300 of the software system of a process for detecting, transmitting, validating, and analyzing service events using an RF-based service confirmation system.

The process begins with RF Tag Detection step 310 when an RF reader detects an RF tag embedded within or associated with an asset when a service tool is brought into proximity. This step ensures that the system can uniquely identify the asset being serviced without manual data entry.

Upon detection, the RF reader captures the unique identifier of the RF tag 320 and generates a timestamp corresponding to the moment of detection. This data serves as the foundation for confirming whether a legitimate service event is taking place.

If the asset is equipped with a control module, the captured data is transmitted to the control module 330. The control module may locally buffer, validate, or preprocess the service event data.

In configurations where the control module is absent or after preprocessing, the data is transmitted wirelessly to a cloud-based platform 340 for centralized storage and analysis.

In Service Event Validation 350, 360, if the system determines that the duration of proximity is insufficient or that the tool type does not match the required service operation, the system flags the event as an invalid service event 350.

If the system confirms that the service tool has maintained proximity for a minimum duration and the tool type corresponds to the expected service action (e.g., waste extraction or cleaning), the system validates the service event as legitimate 360.

The cloud platform stores both valid and invalid service event data and performs analytics on the information. Such analytics may include technician performance metrics, service frequency, asset utilization, and compliance monitoring 370.

Validated service event data is made accessible through a dashboard interface 380. The dashboard provides administrators and managers with real-time and historical visibility into service operations, including alerts for overdue servicing, asset-level performance trends, and technician efficiency comparisons.

In summary, FIG. 6 illustrates how the system automatically transitions from RF tag detection, to information capture, to data transmission, followed by validation, storage, and dashboard visualization. By confirming both the proximity duration and the service tool type, the system ensures that only legitimate servicing actions are recorded as valid service events, thereby enhancing accountability, reducing fraud, and enabling real-time operational oversight.

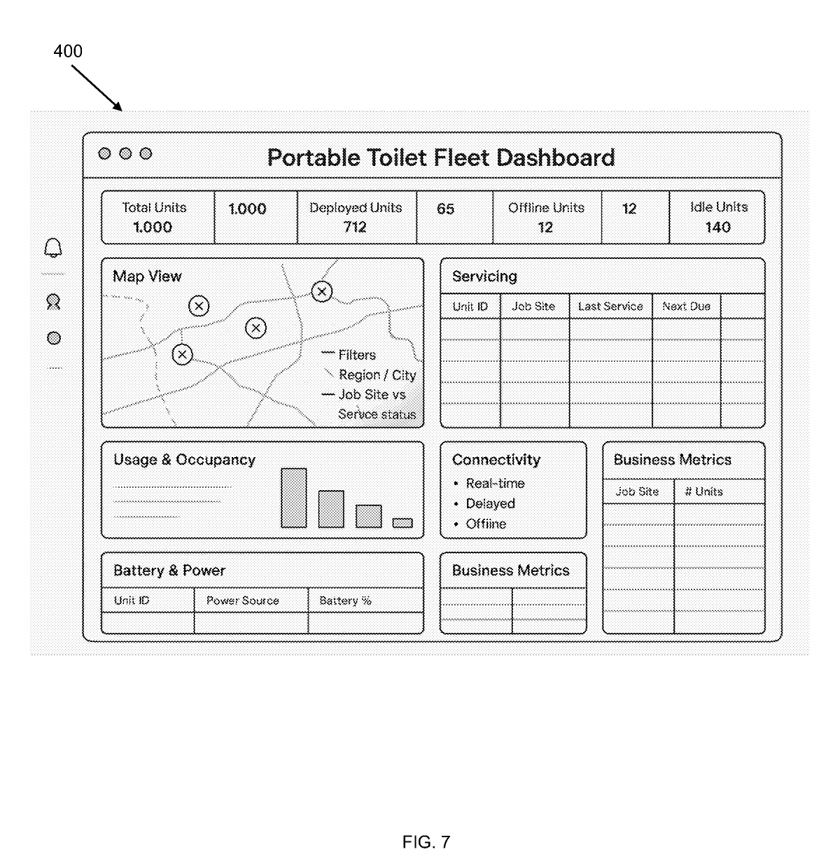

FIG. 7 illustrates an exemplary portable toilet fleet dashboard 400 configured to provide real-time monitoring, servicing oversight, and operational analytics for a distributed fleet of portable sanitation units. The dashboard aggregates data from RF readers, embedded sensors, control modules, and cloud-based analytics to present administrators, managers, and service technicians with actionable insights.

The fleet overview panel displays aggregate statistics of the deployed portable restroom units. Key data includes: Total Units which includes the total number of fleet assets under management. Deployed Units, Units currently in active use at job sites. Offline Units – Units that are disconnected or unavailable due to servicing or connectivity issues. Idle Units– Units that are not currently deployed but remain available for assignment.

System includes a Map View Panel which displays the real-time geographic distribution of portable toilet units. The map is filterable by region, city, job site, or service status. Each unit is represented by a geolocated marker linked to a unique identifier, enabling visual tracking of asset deployment.

A servicing panel provides service scheduling and compliance tracking for each portable unit. Fields include:
Unit Identifier (ID) – Unique code assigned to each unit.
Job Site – Location or project where the unit is deployed.
Last Service Timestamp – Record of the most recent validated service event.
Next Service Due – Calculated date and time when the next scheduled service must occur, based on historical usage, occupancy, or regulatory requirements.

A Usage and Occupancy Panel displays analytics on unit utilization and occupancy levels. Data may include frequency of usage, estimated user counts, and average dwell times. Bar charts and visual indicators may be employed for rapid interpretation by fleet managers.

A Connectivity Panel indicates the communication status of each unit within the network. Categories include:
Real-Time Connectivity – Units actively transmitting live data.
Delayed Connectivity – Units with intermittent or lagged data transmission.
Offline Status – Units with no current data connection.

The system provides a Battery and Power Panel to display power source and battery health metrics for each unit, including:
Power Source – Type of energy powering the unit’s electronic components (e.g., solar, replaceable battery, hybrid).
Battery Percentage – Current charge state of the power supply.

A Business Metrics Panel provides high-level operational and financial insights. Data may include:
Units per Job Site – Number of deployed units at each client site.
Service Efficiency Metrics – Calculations based on average service times, technician productivity, or cost per service event.

The portable toilet fleet dashboard 400 is a cloud-integrated system that combines real-time detection, data transmission, and analytics to streamline fleet operations. The system captures service events through RF tag detections and sensor measurements and transmits captured data to a cloud platform for processing, validation, and storage.

Analyzes historical and real-time data determines servicing needs, usage trends, and maintenance requirements.

The interface displays alerts and metrics through the dashboard for quick administrative decision-making and provides predictive servicing schedules by correlating usage patterns with waste tank capacity and technician performance data.

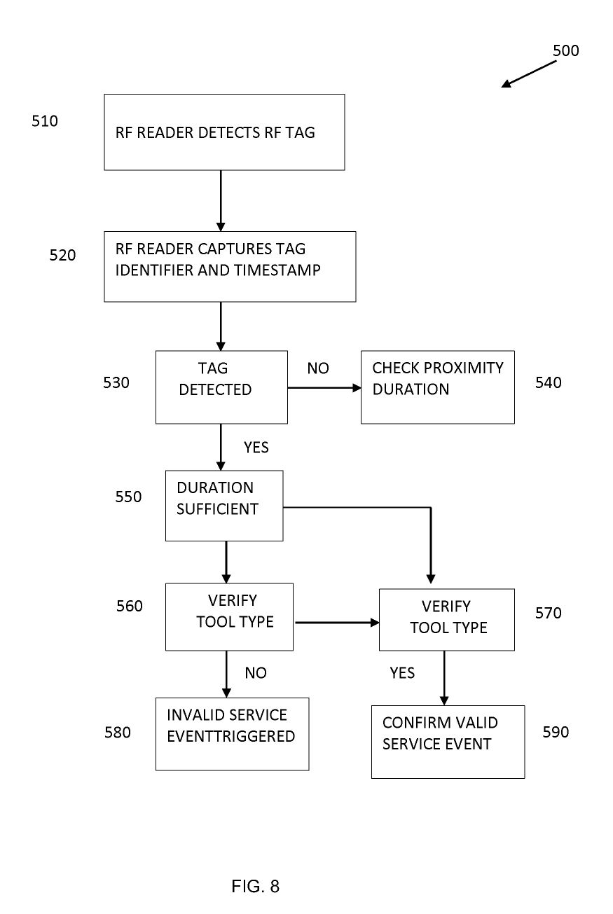

FIG. 8 illustrates a flow process for detecting, validating, and confirming a service event using a radio-frequency (RF) reader in communication with an RF tag associated with an asset 500. The illustrated process ensures accurate service event logging by incorporating sequential validation checks, including RF tag detection, proximity duration analysis, and tool type verification.

At step 510, the RF reader detects the RF tag when brought into proximity with the asset. The RF tag is uniquely associated with the asset and serves as the basis for asset identification during a service operation. At step 520, once the tag is detected, the RF reader captures the unique tag identifier and records a timestamp of detection. The identifier ensures that the specific asset is properly identified, while the timestamp provides a temporal reference for validating the service event.

At step 530, the system determines whether the RF tag has been successfully detected. If no RF tag is detected, the process terminates or returns to scanning for the tag. If the tag is detected, the process advances to the duration verification stage.

At step 540, the system checks whether the RF reader has maintained proximity to the RF tag for a threshold duration. This step is necessary to ensure that the service tool has remained engaged with the asset for a sufficient time to constitute a legitimate service operation, rather than an incidental or transient detection.

At step 550, the system evaluates whether the recorded duration satisfies the minimum threshold requirement. If the duration is insufficient, the system triggers an invalid service event. If the threshold is satisfied, the process continues to tool verification.

At step 560, the system determines whether the service tool in use corresponds to the required tool type for the service operation. For example, a vacuum wand may be required for waste extraction, while a different tool may be necessary for fresh water replenishment.

At step 570, the system verifies the tool type. If the tool type is valid and corresponds to the service requirement, the process advances to confirm the service event. If the tool type does not correspond, the system triggers an invalid service event.

At step 580, an invalid service event is triggered when either the proximity duration or the tool type verification fails. This prevents incomplete, erroneous, or fraudulent service attempts from being registered as valid.

If both the proximity duration and tool type verification are satisfied, the system proceeds to confirm a valid service event 590. The confirmed event is then transmitted to a control module or directly to a cloud platform where it may be stored, analyzed, and displayed through a dashboard interface. The dashboard may provide real-time updates, generate alerts, and track performance metrics for ongoing service management.

Referring to the FIGS. 1-8 again in operation, the technician inserts the vacuum wand 100 into the waste water tank during service. The RF reader 108 detects the RF tag 111 and records a timestamp along with the duration of the contact. This service confirmation data is transmitted wirelessly to a management database. The system may additionally monitor various restroom conditions including waste level, fresh water level, door status, lock engagement, and environmental parameters. Power is supplied by batteries, solar panels, or a combination thereof, and optional amenities such as touchless flushing, lighting, and ventilation can be automatically activated upon user entry.

The combination of RF-based service confirmation, sensor monitoring, and wireless data transmission provides a robust, tamper-resistant solution that enhances accountability, optimizes servicing efficiency, and improves user hygiene in portable restroom operations.

The contactless radio-frequency (RF)-based service confirmation system 100 comprises two primary hardware components: a service confirmation RF reader 108 and a corresponding RF tag 111. The RF reader 108 is mounted on the technician’s servicing equipment, which may include tools such as a vacuum wand 100, freshwater hose, or other sanitation equipment. During a servicing event, when the technician inserts or places the service equipment into or near the portable toilet, the RF reader 108 automatically scans for nearby RF tags 111. Upon detecting an RF tag 111, the reader 108 captures and records critical operational data including:

The unique identifier of the portable toilet (Toilet ID) embedded in the RF tag 111 includes a timestamp indicating the exact moment the service begins and ends, and the total duration for which the servicing tool remains within proximity of the RF tag.

The RF tag 111 is permanently installed inside or in the vicinity of the septic tank of each portable toilet unit. It is configured to emit a unique identification signal and can utilize a variety of wireless communication technologies including, but not limited to, Radio Frequency Identification (RFID) protocols (e.g., EPC Gen2), Bluetooth Low Energy (BLE), Wi-Fi, or Long Range (LoRa) technology. Each RF tag 111 is programmed with a unique identifier that correlates specifically with the associated toilet unit, enabling precise unit-level service tracking.

All data collected by the RF reader 108 during a service event is transmitted wirelessly either to a centralized cloud-based platform or, alternatively, to a secure local database, depending on the system configuration. The transmitted data enables real-time monitoring and historical analysis of service operations. Logged parameters may include, but are not limited to:

The unique Toilet Identification (Toilet ID),

The type of service performed (e.g., waste extraction or freshwater refill), which is inferred from the type of servicing equipment used,

Exact timestamps marking the initiation and completion of service,

The duration of the servicing operation,

The identification of the technician performing the service (Technician ID), and

Optionally, the identification number of the equipment (Equipment ID) utilized. The equipment ID is always logged, while the technician ID is optionally included via additional wearable tags.

Each RF tag 111 is ruggedized and housed in a waterproof, sealed enclosure to ensure long-term durability in challenging environmental conditions, including exposure to moisture, temperature fluctuations, and potential physical impacts. The tag 111 is installed near the waste reservoir of the toilet in a concealed or protected location to prevent tampering or accidental dislodgement during servicing.

Technician tools used in the field are outfitted with integrated RF readers 108 capable of detecting proximity-based wireless signals. When a reader-equipped tool approaches the vicinity of a toilet’s RF tag 111, the reader automatically initiates a detection protocol. Upon establishing communication, the system records the RF tag’s unique identifier and logs the event. Additionally, the system calculates the duration for which the reader-equipped tool remains in the detection zone. This time-based metric is used to validate that the service was not only initiated but maintained for a sufficient period, thereby supporting confirmation of service quality and completeness.

The RF tag 111 is encapsulated in a waterproof, ruggedized enclosure designed to withstand harsh environmental conditions typically encountered in portable sanitation applications, including high humidity, direct moisture exposure, and extreme temperature variations.

The system transmits data in real-time to a cloud dashboard accessible to management. The restroom may also contains a control module with waste level sensors, freshwater level gauges, door and lock sensors and optional temperature/humidity sensors.

The system 100 confirms service automatically without technician interaction, stores proof of service, measures service duration, and provides performance metrics for management. A wireless communications module, such as Wi-Fi, Bluetooth or cellular is also included in the control electronics and coupled to the processor and a suitable antenna. The processor is programmed to monitor usage of the restroom, such as number of full power flushes, number of door openings, or other measurable data, including passage of time. A combination of measured values can be monitored and evaluated by an algorithm to determine service interval. Data for all monitored inputs is stored in the memory coupled to the processor.

When the processor determines that service is required, a wireless signal is sent to the service operator (e.g., a restroom rental or leasing company) to inform the service operator that the restroom requires service. The signal can be in any form, including a text message, email, or an alert through a custom monitoring software interface executing on a dispatcher's or service person's computing device (including portable computing devices such as smart phones, tablets and vehicle navigation computers). The message sent by the processor can include the reason(s) for the service call and the data stored in the memory.

Once a restroom has been serviced and previous data has been downloaded, the processor memory can be “reset” to begin logging new data. All logged data can also be “phoned in” to the service provider via a cell network or other wireless network. The processor can also have its software code wirelessly updated via the service operator's electronic device or via the cellular network. The combination of sensors, processor and wireless communication allows the restroom to self-monitor and notify the service operator of the need for service should it arise before the pre-scheduled service interval. This reduces the chance of a user having a bad experience while using the portable restroom.

The control electronics can further include a GPS decoder component. Thus, a GPS locating feature can be provided to help the service operator find a given restroom for servicing and find a specific restroom within a crowd of units. This GPS feature can be integrated into digital map software on the operator's electronic device to provide directions for driving, service route planning, and asset utilization optimization.

The data monitored and logged by the restroom can include the number of uses, frequency of use, time of each use, length of each use, number of flushes, level of waste in the tank, temperature at points in the day, battery charge level, level of fresh water, charging parameters throughout the day, date and time of last service, etc. This data could be retrieved by the service provider via wireless communication, or Bluetooth communication directly to a mobile computing device.

The system has a control module comprising a microprocessor, memory, and communication module, wherein the RF reader detects the RF tag when the service tool is within proximity, logs a timestamp, and transmits service confirmation data wirelessly to a remote database. The service confirmation data includes: restroom unit ID; service type (vacuum or refill); service start and end time; duration of service; technician and tool identifiers.

The system further comprises one or more sensors configured to detect: waste level; freshwater level; door open/closed status; lock engagement and internal temperature and humidity. The system further comprises a touchless flushing system; automated lighting upon door activation and an electric ventilation fan.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

1. A contactless radio-frequency (RF)-based service confirmation system for a portable restroom unit, comprising:
a) a radio-frequency (RF) tag configured to encode a unique identifier of a portable restroom unit;
b) a service tool comprising an RF reader configured to detect the RF tag when the service tool is positioned in proximity to the radio-frequency (RF) tag, and
d) a wireless communication interface configured to transmit service-confirmation data comprising tag detection, a timestamp, a proximity-duration, and a service tool-verification to a remote management system.

2. The system of claim 1, wherein the radio-frequency (RF) tag is placed within a waste-water tank of the portable restroom unit, and wherein the service tool comprises a vacuum wand having a nozzle sized to engage an intake of the waste-water tank, the RF reader is inhibited from detecting the radio-frequency (RF) tag unless the nozzle is inserted past a predefined depth.

3. The system of claim 1, wherein the service-confirmation data further comprises at least one of: a technician identifier, an equipment identifier, and a job-site identifier.

4. The system of claim 1, further comprising a control module placed within the portable restroom unit and comprising a microprocessor, a memory, and one or more sensors selected from a group consisting of waste-level, fresh-water level, door status, lock engagement, ambient temperature, and ambient humidity, wherein the wireless communication interface is further configured to transmit sensor data to the remote management system.

5. The system of claim 4, wherein the control module is configured to execute firmware that rejects transient detections below a minimum proximity-duration threshold and invalidates events having a non-matching tool type.

6. The system of claim 4, wherein the control module is further configured to generate usage-based service alerts by correlating sensor data with waste water tank capacity thresholds and historic occupancy metrics.

7. The system of claim 4, wherein the control module further comprises a GNSS/GPS receiver and wherein the service-confirmation data includes a geolocation coordinate at the time of validation.

8. The system of claim 4, wherein the control module is further configured to actuate at least one of an interior lighting system, a ventilation fan, or a touchless flushing mechanism in response to a door-open or user-presence event.

9. The system of claim 1, wherein the portable restroom unit further comprises a local dashboard interface configured to display at least one of: a last validated service time, a next due time, a battery state, and a connectivity status.

10. The system of claim 1, wherein the radio-frequency (RF) tag is encapsulated in a sealed, impact-resistant enclosure positioned at a concealed tampered-resistant location.

11. The system of claim 1, wherein the RF reader is mounted on the service tool using a removable locking assembly comprising a spring-loaded sliding lock and a mounting dock.

12. The system of claim 1, wherein the RF reader comprises a sealed top casing and a bottom casing, a main gasket providing environmental protection, a bumper surrounding the casing, a control board secured by fasteners, a dedicated RF antenna for tag detection, and a separate wireless antenna for data transmission.

13. The system of claim 1, wherein the RF reader further comprises an inductive wireless charging interface and operational status indicators.

14. The system of claim 1, further comprising an integrated power supply selected from a rechargeable battery, a solar panel, or a combination thereof.

15. The system of claim 1, wherein the wireless communication interface is selected from cellular, Wi-Fi, BLE, or LoRa and is configured to buffer data during loss of coverage for later forwarding.

16. A method of validating servicing of a portable restroom unit, comprising:
i) detecting, by an RF reader mounted on a service tool, an RF tag disposed within a waste water tank only while the service tool is inserted into the tank;
ii) recording a timestamp and a proximity-duration of continuous detection;
iii) verifying a service tool type against a required service operation;
iv) confirming the service event as valid when both the proximity-duration and the service tool-type verification satisfy predetermined thresholds; and
v) transmitting the confirmed service event and, optionally, sensor data from the restroom unit to a remote management platform.

17. The method of claim 16, further comprising rejecting the events having a detection duration below a minimum threshold.

18. The method of claim 16, further comprising associating the service event with at least one of: a technician ID, an equipment ID, or a wearable tag information.

19. The method of claim 16, further comprising logging sensor measurements including at least one of: waste level, fresh water level, door status, lock status, temperature, or humidity, in temporal association with the validated event.

20. The method of claim 16, further comprising computing a predicted next service time based on validated events and historical occupancy data.
